(19) United States
(12) Patent Application Publication
(10) Pub. No.: US 2016/0318424 A1
(43) Pub. Date: Nov. 3, 2016

(54) EASY ENTRY SEAT ASSEMBLY HAVING AN OBJECT DETECTION FEATURE

(71) Applicant: LEAR CORPORATION, Southfield, MI (US)

(72) Inventors: Andrzej Dlugokecki, Troy, MI (US); David A. Hein, Sterling Heights, MI (US); Arjun Yetukuri, Rochester Hills, MI (US)

(21) Appl. No.: 14/698,390

(22) Filed: Apr. 28, 2015

(51) Int. Cl. B60N 2/10; B60N 2/44; B60N 2/68

(52) U.S. Cl. CPC B60N 2/10; B60N 2/68; B60N 2/44

(57) ABSTRACT

An easy entry seat assembly may include a seat frame having a seat bottom and a backrest. The seat frame may be connected to and/or supported by an easy entry mechanism relative to a support surface for movement between an upright seated position and a forward easy entry position. The seat frame may include a latch configured to lock the seat assembly in the upright seated position. An object detector may be provided on the seat frame to detect the presence of an object located in a path of the latch as the seat frame is moved from the forward easy entry position to the upright seated position.

### TECHNICAL FIELD

The present disclosure relates generally to easy entry seat assemblies, including an easy entry seat assembly having an object detection feature configured to detect the presence of an object located in a path of a seat latching mechanism as the seat assembly is moved from a forward easy entry position to an upright seated position.

### BACKGROUND

Easy entry seat assemblies can be used in automobiles and other types of vehicles to help provide entry or access to a rear row of seats within the vehicle. In a non-limiting example, an easy entry seat assembly may include a seat frame having a seat bottom and a backrest. The backrest may be supported for pivotal movement relative to the seat bottom, although such is not required. The seat frame may be supported relative to a floor of the vehicle for movement between an upright seated position and a forward easy entry position. For example, the seat frame may be supported on an easy entry mechanism, which may be provided between the seat bottom and a pair of seat track assemblies. The easy entry mechanism can be configured to facilitate pivotal movement of the seat frame between the upright seated position and the forward easy entry position to, inter alia, facilitate rear seat ingress/egress for an occupant.

A latch or latching mechanism may be provided on the seat frame to lock the seat frame in the upright seated position and to selectively release the seat frame for movement to the forward easy entry position. For example, the latching mechanism may include a seat latch provided at or near a lower, rear portion of the seat bottom, and a floor latch provided on a floor of the vehicle or on at least one of the seat track assemblies. Thus, as the seat frame is moved from the forward easy entry position in a backward direction to an upright seated position, the seat latch is moved toward the floor latch and is configured to engage the floor latch to lock the seat assembly in the upright seated position.

In easy entry seat assemblies, including powered easy entry assemblies, it may be desirable to detect the presence of an object located in a path of the latch or seat latching mechanism as the seat assembly is moved from the forward easy entry position to the upright seated position in order to stop and/or reverse movement of the easy entry seat assembly.

### SUMMARY

An easy entry seat assembly may include a seat frame having a seat bottom and a backrest. The seat frame may be connected to and/or supported by an easy entry mechanism relative to a support surface for movement between an upright seated position and a forward easy entry position. The seat frame may include a latch or latching mechanism configured to lock the seat assembly in the upright seated position. An object detector may be provided on the seat frame to detect the presence of an object located in a path of the latch or latching mechanism as the seat frame is moved, for example, such as from a forward easy entry position to an upright seated position.

Various aspects of the present disclosure will become apparent to those skilled in the art from the following detailed description of the various embodiments, when read in light of the accompanying drawings.

### BRIEF DESCRIPTION OF THE DRAWINGS

Embodiments of the present disclosure will now be described, by way of example, with reference to the accompanying drawings.

FIG. 1 is a side view of an easy entry seat assembly, which is generally shown in an upright seated position.

FIG. 2 is a side view of the easy entry seat assembly of FIG. 1, which is generally shown in a forward easy entry position.

FIG. 3 is a side view of the easy entry seat assembly of FIG. 1 including an object detection shield in accordance with an embodiment of the present disclosure, wherein the easy entry seat assembly is generally shown in a forward easy entry position.

FIG. 4 is a side view of the easy entry seat assembly of FIG. 3, wherein the easy entry seat assembly is generally shown during movement from the forward easy entry position to an upright seated position.

FIG. 5 is an enlarged prospective view showing a rear portion of the easy entry seat assembly of FIG. 3, wherein the easy entry seat assembly is generally shown in a position prior to reaching the upright seated position and the object detection shield is generally shown in a first or active position.

FIG. 6 is an enlarged prospective view showing a rear portion of the easy entry seat assembly of FIG. 3, wherein the seat is generally shown in the upright seated position and the object detection shield is generally shown in a second or inactive position.

FIG. 7 is a side view of the easy entry seat assembly of FIG. 1 including an object detection sensor in accordance with an embodiment of the present disclosure, wherein the easy entry seat assembly is generally shown in a forward easy entry position.

FIG. 8 is a side view of the easy entry seat assembly of FIG. 7, wherein the easy entry seat assembly is generally shown during movement from the forward easy entry position to the upright seated position.

FIG. 9 is an enlarged rear view of the easy entry seat assembly of FIG. 7, wherein the easy entry seat assembly is generally shown in an intermediate position prior to reaching the upright seated position.

FIG. 10 is an enlarged prospective view showing a rear portion of the easy entry seat assembly of FIG. 7, wherein the seat assembly is generally shown in the upright seated position.

### DETAILED DESCRIPTION

Reference will now be made in detail to embodiments of the present disclosure, examples of which are described herein and illustrated in the accompanying drawings. While the present disclosure will be described in conjunction with embodiments, it will be understood that they are not intended to limit the invention to these embodiments. On the contrary, the present disclosure is intended to cover alternatives, modifications and equivalents, which may be included within the spirit and scope of the invention as defined by the appended claims.

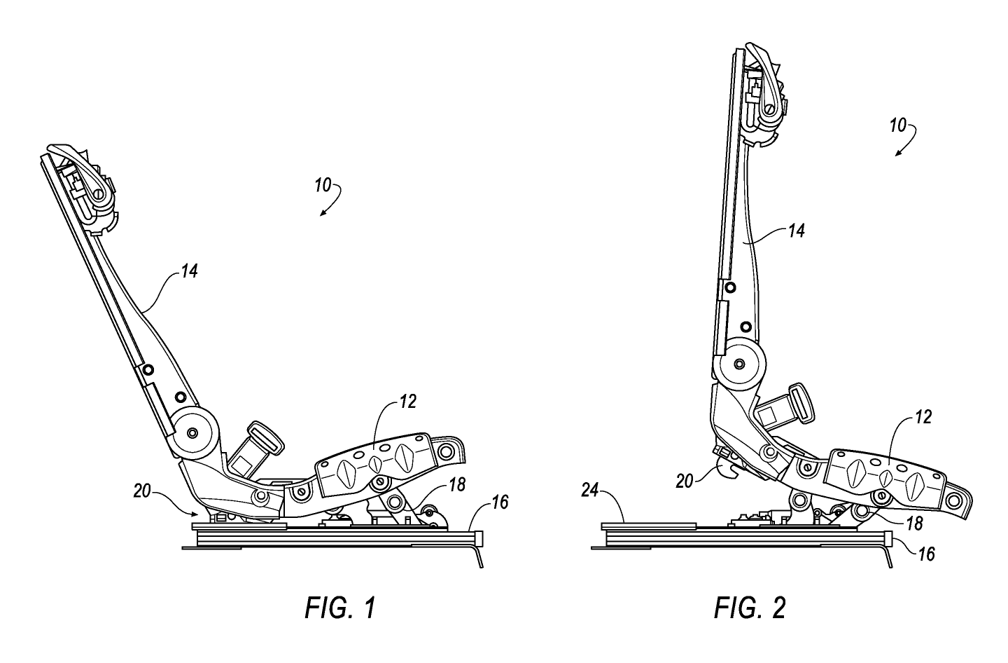

Referring now to FIGS. 1 and 2, an easy entry seat assembly is generally illustrated at 10. In a non-limiting embodiment, the easy entry seat assembly 10 may be used in an automobile or other type of vehicle having multiple rows of seats. For example, as will be generally explained below, the easy entry seat assembly 10 may be configured to facilitate entry or access to a rear row of seats in the vehicle. It should be appreciated, however, that the present disclosure of an easy entry seat assembly is not limited for use in vehicles, but can be used in any suitable environment and for any suitable purpose without departing from the scope of the present disclosure.

As generally shown, the easy entry seat assembly 10 may include a seat frame having, among other features, a seat bottom 12 and a backrest 14. The backrest 14 may be supported for pivotal movement relative to the seat bottom 12, although such is not required. The seat bottom 12 may be supported on a pair of seat track assemblies 16, which in turn can be secured to a support surface of the vehicle, such as a floor for example. In other embodiments, the seat bottom 12 may be secured directly or otherwise indirectly to the floor of the vehicle.

The seat bottom 12 may be supported on the seat track assemblies 16 or on the floor by an easy entry mechanism 18. The easy entry mechanism 18 may be configured to support the seat frame for movement relative to the seat track assemblies 16 or the floor. For example and without limitation, the easy entry seat assembly 10 may be pivotally movable between an upright seated position—e.g., as generally shown in FIG. 1, and a forward easy entry position—e.g., as generally shown in FIG. 2, or intermediate positions. As such, the easy entry mechanism 18 may include a suitable arrangement of support brackets and pivotal linkages to accomplish functions described herein and below, along with other functions. In a non-limiting embodiment, the easy entry seat assembly 10 may also be configured as a powered seat assembly and may include a suitable power source, such as an electric motor, to move the easy entry seat assembly 10 between the upright seated position and the forward easy entry position.

The easy entry seat assembly 10 may also include a latch 20. The latch 20 can be configured to lock or otherwise secure the easy entry seat assembly 10 in the upright seated position. For example and without specific limitation, as generally shown in FIG. 2, the latch 20 may comprise a seat latch 22 provided on a lower, rear portion of the seat bottom 12. A floor latch 24 may be provided on a floor of the vehicle or on at least one of the seat track assemblies 16. In operation, the seat latch 22 may be configured to engage the floor latch 24 to lock the easy entry seat assembly 10 in the upright seated position. The latch 20 may also be configured to selectively release the easy entry seat assembly 10 for movement from the upright seated position to the forward easy entry position. For example and without limitation, the latch 20 can be operable by a lever or other operating device provided on an easily accessible location of the easy entry seat assembly 10.

According to an embodiment of the present disclosure, the easy entry seat assembly 10 may also include an object detector. As will be generally explained below, the object detector can be configured to detect the presence of an object, such as an occupant's foot for example, that may be located in a path of the latch 20 as the easy entry seat assembly 10 is moved from the forward easy entry position back to the upright seated position. Among these and other functions, the object detector may also provide an output to a control unit or other operating device of the vehicle in response to detection of an object in order to stop and/or reverse movement of the easy entry seat assembly 10.

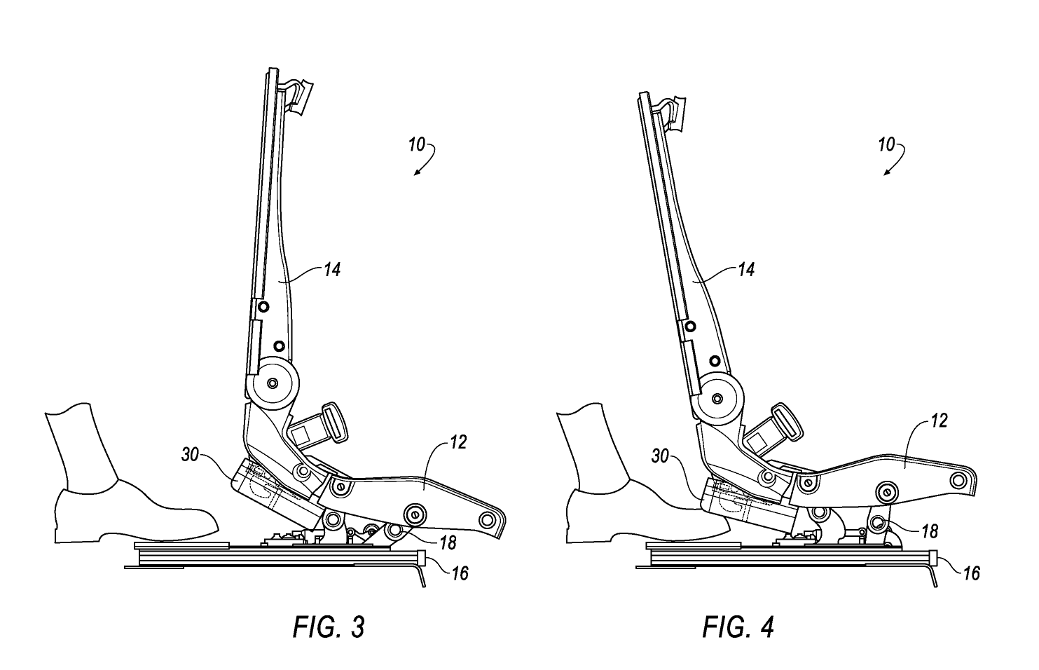

In an embodiment, the object detector may comprise a mechanical component, which can be configured to detect the presence of an object located in the path of the latch 20. For example, as generally shown in FIGS. 3 through 6, the object detector may include, among other things, an object detection shield, such as generally illustrated at 30. The object detection shield 30 may be located on a lower, rear portion of the seat bottom 12 and adjacent to or near the seat latch 22. As generally shown in FIGS. 3 and 4, the object detection shield 30 may be configured to extend downwardly from the seat bottom 12 beyond an outer edge of the seat latch 22. Moreover, the object detection shield 30 may optionally be configured to at least partially or fully conceal the seat latch 22, although such is not necessary.

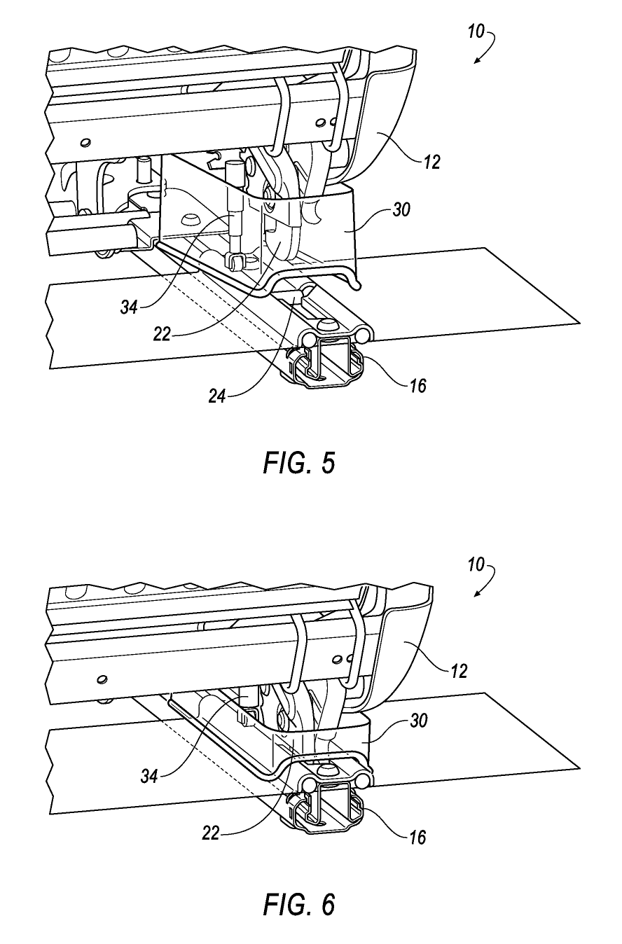

As generally shown in FIGS. 5 and 6, the object detection shield 30 may be a collapsible or otherwise flexible component that can be movable between a first or extended position and a second or collapsed position. For example and without limitation, the object detection shield 30 can be a telescoping-type component that can collapse upon itself when a compression force is applied thereto. In alternative embodiments, however, the object detection shield 30 may be configured as other suitable components that may be movable between an extended position and a collapsed or compressed position.

The object detection shield 30 may also include a probe 34, which can be configured to detect movement of the object detection shield 30 between the first and second positions. For example and without limitation, the probe 34 may be connected or otherwise provided between a portion of the seat bottom 12 and a collapsible or movable portion of the object detection shield 30. The probe 34 may also be a collapsible component, such as a telescoping-type probe for example, that is capable of detecting movement of the object detection shield 30 and producing an output in response thereto. In embodiments, an easy entry mechanism may be configured to move a seat linearly forward/aft in response to detection of an identified obstacle by an object detector. Moreover, in some applications, the two relevant positions may be a forward easy entry position and a seated position (that could also be considered an upright position if one is referring to position of the seat back being rearward of the easy entry position, which typically is forward of vertical in a linear fore/aft easy entry seat).

An operation of the object detection shield 30 according to an embodiment of the present disclosure will be generally explained with reference to FIGS. 3 and 4. As generally shown in FIG. 3, when the easy entry seat assembly 10 is moved from the forward easy entry position back toward the upright seated position, the object detection shield 30 may remain in a first or active position. In this position, the object detection shield 30 is in the extended position.

However, as generally shown in FIG. 4, if an object is or otherwise becomes present in a path of the latch 20 as the easy entry seat assembly 10 continues to move toward the upright seated position, then the object detection shield 30 may come into contact with the object. As the easy entry seat assembly 10 continues to move toward the upright seated position, the object detection shield 30 will begin to collapse on itself as a result of the object, thereby triggering the probe 34. In response, the probe 34 may then send a signal to a control unit or other device of the vehicle to stop and/or reverse movement of the easy entry seat assembly 10 toward the forward easy entry position.

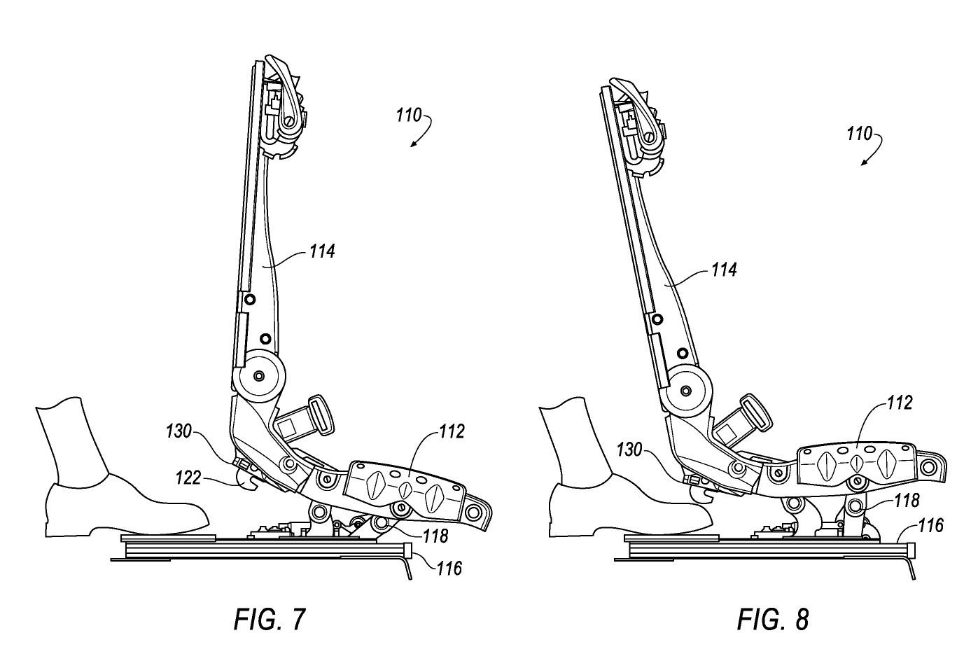

Referring now to FIGS. 7 through 10, an easy entry seat assembly according to another embodiment of the present disclosure is generally shown at 110. The easy entry seat assembly 110 may include similar structural features as described and generally shown above in the previous embodiment, although such is not required. Similar features have been numbered with common reference numerals but generally have been increased by a value of 100 (e.g., 110, 120, 130, etc.). It should be appreciated that similar features can be structured similarly, operate similarly, and/or have the same function unless otherwise indicated by the drawings or this description.

For example and without limitation, the easy entry seat assembly 110 may include a seat frame having a seat bottom 112 and a backrest 114. The seat bottom 112 may optionally be supported on a pair of seat track assemblies 116, which in turn can be secured to a floor of the vehicle. As generally shown, the seat bottom 112 may be supported on the seat track assemblies 116 or the floor for pivotal movement by a reclining mechanism 118. As such, the easy entry seat assembly 110 may be movable between an upright seated position and a forward easy entry position. The easy entry seat assembly 110 may also include a latching mechanism 120 to lock or otherwise secure the easy entry seat assembly 110 in the upright seated position.

The easy entry seat assembly 110 may also include an object detector. As generally explained above in the previous embodiment, the object detector can be configured to detect the presence of an object, such as an occupant's foot for example, that may be located in a path of the latching mechanism 120 when the easy entry seat assembly 110 moves from the forward easy entry position back to the upright seated position.

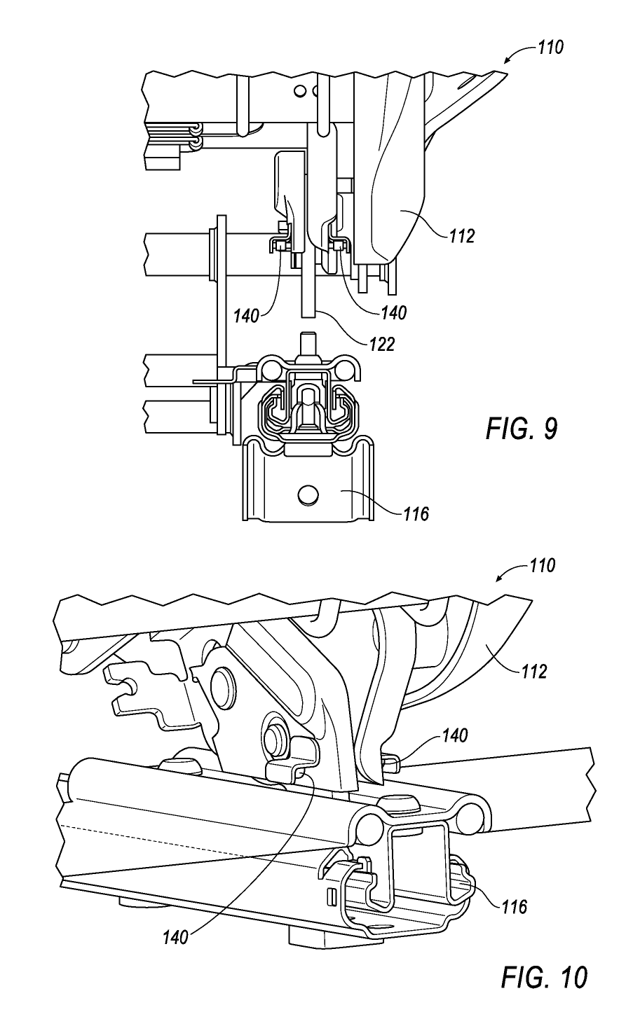

In this embodiment, however, the object detector may comprise an electrical component, which can be configured to sense the presence of an object. For example, as generally shown in FIGS. 9 and 10, the object detector may include an object detection sensor, such as generally illustrated at 140. The object detection sensor 140 may be located on a lower, rear portion of the seat bottom 112 and adjacent to or near the latching mechanism 120. In alternative embodiments, however, the object detection sensor 140 can be provided in other suitable locations on the seat frame or the seat track assemblies 116 of the easy entry seat assembly 110.

In a non-limiting embodiment, the object detection sensor 140 may be a non-contact sensor that is capable of sensing or detecting the presence of an object in a vicinity thereof. For example and without limitation, the object detection sensor 140 can be a capacitive sensor or the like. In alternative embodiments, however, the object detection sensor 140 may be other suitable types or styles of sensors that can be configured to sense the presence of an object within a suitable range or distance thereof.

An operation of the object detection sensor 140 according to an embodiment of the present disclosure will be generally explained with reference to FIGS. 7 and 8. As generally shown in FIG. 7, the easy entry seat assembly 110 may be movable from the forward easy entry position back toward the upright seated position. However, as generally shown in FIG. 8, if an object is or otherwise becomes present in a path of the latching mechanism 120 as the easy entry seat assembly 110 continues to move towards the upright seated position, then the object detection sensor 140 may sense or detect the object. In response, the object detection sensor 140 may send a signal to a control unit or other device of the vehicle to stop and/or reverse movement of the easy entry seat assembly 110 toward the forward easy entry position.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. An easy entry seat assembly comprising:
a seat frame having a seat bottom and a backrest;
an easy entry mechanism configured to support the seat frame relative to a support surface for movement between an upright seated position and a forward easy entry position;
a latch provided on the seat frame and configured to lock the seat frame in the upright seated position; and
an object detector provided on the seat frame to detect a presence of an obstacle located in a path of the latch as the seat frame is moved from the forward easy entry position to the upright seated position.

2. The easy entry seat assembly of claim 1, wherein the easy entry mechanism supports the seat frame on a pair of seat track assemblies.

3. The easy entry seat assembly of claim 1, wherein the seat frame is supported for pivotal movement between the upright seated position and the forward easy entry position.

4. The easy entry seat assembly of claim 1, wherein the latch includes a seat latch provided on the seat bottom.

5. The easy entry seat assembly of claim 1, wherein the object detector includes a mechanical component configured to detect the presence of an obstacle located in a path of the latch.

6. The easy entry seat assembly of claim 5, wherein the object detector includes an object detection shield provided on the seat frame adjacent to or near the latch.

7. The easy entry seat assembly of claim 6, wherein the object detection shield is a collapsible or flexible component, and a portion of the object detection shield is movable between a first or extended position and a second or collapsed position.

8. The easy entry seat assembly of claim 7, wherein the object detector further includes a probe provided between a portion of the seat frame and a movable portion of the object detection shield.

9. The easy entry seat assembly of claim 8, wherein the probe is configured to provide an output in response to movement of the object detection shield.

10. The easy entry seat assembly of claim 1, wherein the object detector includes an electrical component configured to detect the presence of an obstacle located in a path of the latch.

11. The easy entry seat assembly of claim 10, wherein the object detector includes a sensor provided on the seat frame adjacent to or near the latch.

12. The easy entry seat assembly of claim 11, wherein the sensor is a capacitive sensor.

13. The easy entry seat assembly of claim 11, wherein the sensor is configured to provide an output in response to detection of an object in the path of the latch.

14. An easy entry seat assembly for use in a vehicle, the easy entry seat assembly comprising:
a pair of seat track assemblies configured to be secured to a floor of the vehicle;
a seat frame having a seat bottom and a backrest;
an easy entry mechanism supporting the seat frame on the seat track assemblies for pivotal movement between an upright seated position and a forward easy entry position;
a latch provided on the seat frame for locking the seat frame in the upright seated position; and
an object detection device to detect a presence of an obstacle located in a path of the latch as the seat frame is moved from the forward easy entry position to the upright seated position.

15. The easy entry seat assembly of claim 14, wherein the object detection device includes an object detection shield provided on the seat frame adjacent to or near the latch.

16. The easy entry seat assembly of claim 15, wherein the object detection shield is a collapsible or flexible component, and a portion of the object detection shield is movable between a first or extended position and a second or collapsed position.

17. The easy entry seat assembly of claim 16, wherein the object detection device further includes a probe provided between a portion of the seat frame and a movable portion of the object detection shield.

18. The easy entry seat assembly of claim 14, wherein the object detection device includes an electrical component configured to detect the presence of an obstacle located in a path of the latch.

19. The easy entry seat assembly of claim 18, wherein the object detection device includes a sensor provided on the seat frame adjacent to or near the latch.

20. The easy entry seat assembly of claim 19, wherein the sensor is a capacitive sensor.
